(19) United States
(12) Patent Application Publication
(10) Pub. No.: US 2012/0324355 A1
(43) Pub. Date: Dec. 20, 2012

(54) SYNCHRONIZED READING IN A WEB-BASED READING SYSTEM

(75) Inventors: Ernest V. Mbenkum, Toronto (CA); Mark Hempel, Edina, MN (US)

(73) Assignee: SUMBOLA, INC., Toronto (CA)

(21) Appl. No.: 13/475,268

(22) Filed: May 18, 2012

Related U.S. Application Data
(63) Continuation-in-part of application No. 13/163,795, filed on Jun. 20, 2011.
Application No. 13/163,795 is a continuation-in-part of application No. 13/163,797, filed on Jun. 20, 2011.
Application No. 13/163,797 is a continuation-in-part of application No. 13/474,024, filed on May 17, 2012.
(60) Provisional application No. 61/622,778, filed on Apr. 11, 2012.

(51) Int. Cl. G06F 3/16

(52) U.S. Cl. 715/727

(57) ABSTRACT

A system and method is presented for the creating a synchronized reading session in a web based reading environment. Data is maintained in a database relating to books, chapters, pages. Through a speaker interface, one user operating a speaker computer controls the pages that appear on the interfaces of all participants in the synchronized reading session. The speaker interface also accepts an audio input that is also shared with the interfaces of all participants in the session. All participants view the same pages and hear the same audio in synchronization. Temporary audio input abilities may be granted to a particular participant computers in order to allow a participant to ask a question. Temporary page control can also be granted to a particular participant computer. The speaker computer retains the ability to revoke temporary control granted to participant computers.

### RELATED APPLICATIONS

The present application is a continuation-in-part of U.S. patent application Ser. No. 13/163,795, filed Jun. 20, 2011, a continuation-in-part of U.S. patent application Ser. No. 13/163,797, also filed on Jun. 20, 2011. The present application is also a continuation-in-part of U.S. patent application Ser. No. 13/474,024, filed on May 17, 2012, which claims the benefit of U.S. Provisional Application No. 61/622,778, filed on Apr. 11, 2012. Each of these priority applications is hereby incorporated by reference.

### FIELD OF THE INVENTION

The present application relates to the field of document review. More particularly, the described embodiments relate to a system and method for allowing multiple parties to view a web-based publication and listen to a speaker reading the publication in synchronization over a network.

### BRIEF DESCRIPTION OF THE DRAWINGS

FIG. 1 is a block diagram showing a computerized system in used by a plurality of users, authors, and publishers.

FIG. 2 is a block diagram showing a server computer operating a web server to present interfaces over the World Wide Web.

FIG. 3 is a block diagram showing database elements used to create a synchronized reading system.

FIG. 4 is a diagram showing a reading interface for one embodiment of the present invention with a synchronized reading toolbox.

FIG. 5 is a diagram showing a speaker interface for creating a synchronized reading session.

FIG. 6 is a diagram showing a speaker interface for conducting a synchronized reading session.

FIG. 7 is a diagram showing a participant interface for participating in a synchronized reading session.

FIG. 8 is a diagram showing a participant interface for asking a question in a synchronized reading session.

FIG. 9 is a diagram showing a participant interface for controlling page changes during a synchronized reading session.

FIG. 10 is a flow chart showing a method for participating in a synchronized reading session.

FIG. 11 is a flow chart showing a method for conducting a synchronized reading session.

### DETAILED DESCRIPTION

Overview

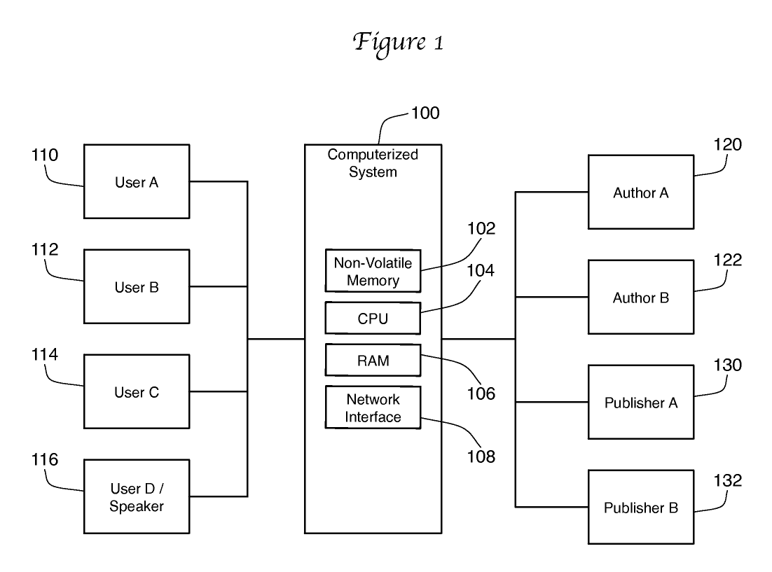

FIG. 1 is a block diagram showing a plurality of users 110-116, authors 120-122, and publishers 130-32 that are connected to a computerized system 100. The computerized system 100 provides an interactive interface to users 110-116 that allows users to page through and read one or more books. In the present description, users 110-116 are those individuals who use the computerized system 100 to read a book, to review information and content about the book, to highlight and license portions of a book, and to interact with other parties concerning that book. Authors 120-122 are those individuals who authored the books that are available for reading on the system 100. Publishers 130-132 are the entities that publish the printed version of the books, or entities that otherwise assist in the publicity for or distribution of the books.

In this description, the term author, publisher, and book are used to describe an embodiment of the present invention. However, it is not necessary that the material being read by a user constitute a book per se. For instance, the content may be a journal article, a news report, etc. The authors using the system would not then be book authors, but could be an article writer, poet, journalist, or any other type of content creator. The publisher also need not be a written book publisher, but could be any entity that works on publicity or distribution of the written content. Consequently, the word book should be construed broadly to mean written content, the word author should be construed to mean the creator of the written content, and the word publisher should be construed to mean an entity involved in publicity or distribution of the written content.

The computerized system 100 includes a set of software instructions or interfaces stored on a non-volatile, non-transitory, computer readable medium 102 such as a hard drive or flash memory device. A digital processor 104, such as a general purpose CPU manufactured by Intel Corporation (Mountain View, Calif.) or Advanced Micro Devices, Inc. (Sunnyvale, Calif.) accesses and performs the software. To improve efficiency, processor 104 may load software stored in memory 102 into faster, but volatile RAM 106. Data operated upon by the software can also be stored in non-volatile memory 102 and retrieved into RAM 106 for analysis, recording, and reporting. The computer system 100 further includes a network interface 108 to communicate with other computerized devices across a digital data network. In one embodiment, the network is the Internet or an Intranet, and the network interface 108 includes TCP/IP protocol stacks for communicating over the network. The network interface 108 may connect to the network wirelessly or through a physical wired connection. Instead of being a single computer with a single processor 104, the computerized system 100 could also implemented using a network of computers all operating according to the instructions of the software.

By using the computerized system 100, users 110-116 not only receive access to the book that they wish to read, but they also participate on a social community related to that book. These social communities include content created by, and interaction between other users 110-116 who are also reading the book, the author or authors 120-122 of the book, and other entities such as publishers 130-132 who are publicizing and attempting to generate interest in the book. This content can include notes about a particular page, chapter, or section of the book created by the users 110-116.

User D 116 shown in FIG. 1 is also a shown as a “Speaker.” This user D 116 is able to read portions of the book into a microphone operating on their computer. The audio from this speaker 116 is transmitted to the computerized system 100 and shared with selected other users 110-114. In the preferred embodiment, this speaker audio is transmitted to the other users 110-114 along with the page currently being viewed by the speaker 116. In this way, the speaker 116 can control the pages viewed by the other users 110-114 so as to have the speaker audio remain in synch with the displayed pages of the book being read.

Implementation as a Web Server

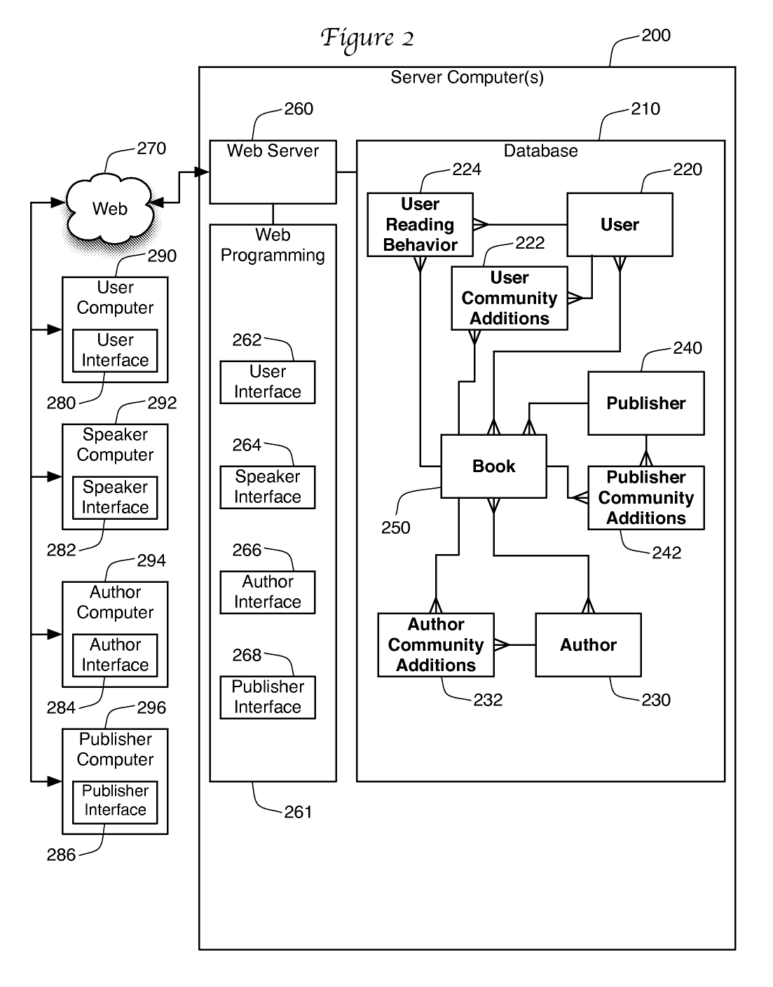

The computerized system 100 of FIG. 1 can be implemented as one or more web server computers 200 as shown in FIG. 2. The computerized system 200 is capable of storing information about all of the parties that use the system 200. In the preferred embodiment, the server computer 200 stores this information in a database 210. This information can be maintained as separate tables in a relational database, or as database objects in an object-oriented database environment within the database 110. FIG. 2 shows the database 210 with tables or objects for users 220, authors 230, publishers 240, and books 250. This allows the database 210 to maintain information about the users 110-116, authors 120-122, and publishers 130-132 that may access the server computer 200. Of course, the table or object entities shown in FIG. 2 should not be considered to show actual implementation details of the database 210, since it is well within the scope of the art to implement this type of data using a variety of entity architectures. The entities shown are exemplary, intended to aid in the understanding of the data maintained by the system database 210 in this embodiment. For example, it would be well within the scope of the present invention to divide information about users 220 into multiple tables or objects, instead of the single user entity 220 shown in FIG. 2. Similarly, it would be possible to implement the database 210 such that information about users, authors, and publishers all use a single database table or object, where the role (user, author, publisher) for each instance is defined using a field within that table or object. Finally, it is not even necessary to implement these entities as formal tables or objects, as other database paradigms could also effectively implement these types of data structures.

Relationships between these entities 220-250 as well as the other entities in the database 210 are represented in FIG. 2 using crow's foot notation. For example, FIG. 2 shows that a book 250 may have multiple authors 230, but only a single publisher 240. Each author 230 and publisher 240 can, in turn, have multiple books 250. Users 220 in the database 210 can be associated with multiple books 250, and each book 250 can itself be associated with multiple users 220. “Associations” (or “relationships”) between database entities 220-250 can be implemented through a variety of known database techniques, such as through the use of foreign key fields and associative tables in a relational database model.

The database also tracks the contributions made to the community surrounding a book 250 by each of the various users. For instance, each user 220 can make multiple user community additions 222 to the system 200. These additions 222 may include highlights, page notes, chapter comments, book reviews and ratings, chat room contributions, recordings, etc. While each user 220 may make user community additions 222 about any book 250 with which they are associated in the database 210, each user community addition 222 is related to only one particular book 250. Similarly, each author 230 may make author community additions 232 to the database 210, thereby allowing the author 230 to make comments, updates, and blog posts about one of their books 250. The various community additions 222, 232, 242 that are associated with a book 250 together constitute the social community oriented around that book 250.

Users of the system 200 are given access to a book's content by associating their user record 220 with the appropriate book record 250 in the database. The text of the book is stored in the book record 250 or in related database records. Users whose record 220 is associated with the book 250 are granted access to the books' related community additions 222, 232, 242.

User interaction with the book's content through the sever computer 200 are stored in user reading behavior records 224. These records can indicate when a user purchased a book, or started reading that book. Additional records can track each page turn (or “page clicks”) by the user. Only by tracking user interaction with a book at the page level can some of the most useful information about the book and the user be generated.

The database 210 is used by a web server 260 operating on one or more of the server computers 200 to generate the various interfaces used by the system 10. In particular, web programming 261 exists that defines how to create a user interface 262, a speaker interface 264, an author interface 266, and a publisher interface 268 using the data in the database 210. This programming 261 allows the web server 260 to transmit over the World Wide Web 270 (or an intranet) a user interface 280 that can be seen by a browser operating on a computer 290 for the benefit of a user. Similarly, the web server 260 can manage a speaker interface 282 on a browser operating on a speaker computer 292, an author interface 284 on browser operating on an author computer 294, and a publisher interface 286 operating on a publisher computer 296. Each computer 290, 292, 294, 296 could be a standard personal computer operating a Microsoft Windows, Linux, or Apple Mac OS operating system. Alternatively, these computers 290-296 could be mobile devices, such as smart phones or tablet computers, operating Google Android, Apple iOS, or Microsoft Windows Phone operation system. In addition, the device could be a “smart” or Internet enabled television.

User Related Data

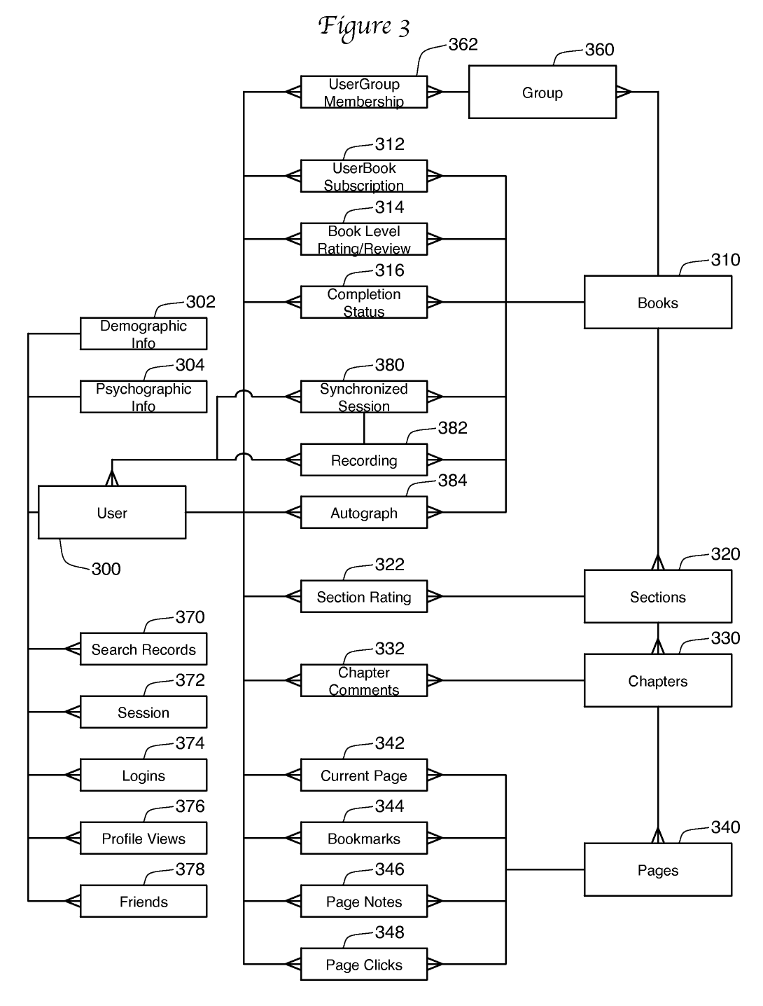

FIG. 3 shows the database elements 300-384 used by the database 210 to track information about users and their interactions with books. The user database element 300 is connected to the book element 310 primarily by the UserBook subscription 312. This element 312 indicates that the user 300 has purchased or otherwise obtained access to the book 310. Relationships between entities in FIG. 3 can be established using any of the standard techniques known in the field of database design. In the present case, a unique user ID is assigned to each user entry 300, and a unique book ID is assigned to each book entry 310. In one embodiment, other entities that relate to the user 300 or book 310 make that relationship using the user ID or book ID, respectively, either as a direct foreign key entry into the related record or through the use of associative tables.

User information, such as the user's name, address, username, password, etc. is stored in the user database element 300. Related records can also be created to store similar information. For instance, the database elements in FIG. 3 separate demographic info 302 (such as age, sex, geographic location, and income) and psychographic info 304 (such as reading preferences and past purchasing behavior) into separate elements from the user 300, even though it would be a simple matter to integrate this same information into the definition of a user table or object 300. The book element 310 itself contains information about the book (such as the book's title, date of copyright, ISBN number, etc.), although such data could also be located in separately defined database elements.

In the preferred embodiment, users 300 who have finished reading a book 310 are permitted to create a book rating and review 314 for the book 310. Users 300 who have not completed the book 310 may leave comments about parts of a book, but may not created a book level rating or review 314. The completion status detailing a user's interaction with a book is stored in database element 316.

In the embodiment shown in FIG. 3, books 310 are conceptually subdivided into sections 320. Sections 320, in turn, are subdivided into chapters 330, which are made up of pages 340. Each of these subdivisions is represented by separate database elements. In the preferred embodiment, the actual content or text of the book 410 is stored in the page level database element 440. One of the primary advantages of these subdivisions 320-340 is that user community additions relating to this book can be associated with the particular subdivision. For instance, users 300 are allowed to create separate section ratings 322 for each section 320, create chapter comments 332 for each chapter 330, create bookmarks 344 and page notes 346 for each page, and to create highlights 352 for page portions 350.

On the page 340 level, the database tracks the current page 342 being reviewed by the user. By separately storing this information, the system allows a user to quickly return to their place within a book at later time, even after a significant delay between reading sessions. Multiple pages in a book 310 that are of particular interest to a user can be marked using bookmarks 344. The page level notes data structure 346 can contain a note left by the user, as well as the user's preferences about the note. For instance, the user can designate that the note is a private note that should be viewed only by the user, or designate that the note is public, thereby allowing the system 100 to share the note with all readers reaching that same page 340 of the book 310. In the preferred embodiment, public notes 346 are accessible to all users 300 of the book 310, thereby allowing communication between otherwise unrelated users 300. In one embodiment, page notes 346 can relate to other notes 346, thereby allowing the creation of threaded, back-and-forth discussions within the book's community.

In another embodiment, the user can participate in a book's community as part of a group 360. A group 360 is a subset of all users that are reading a particular book 310. In this embodiment, a third option of sharing page notes 346 can be presented, where notes can be viewed by members of the group 360 but not by other readers of the book 310. The membership of a user 300 in a group 360 is defined by the UserGroup membership database entity 362.

Another advance made by the present invention relates to the ability to track page clicks 348. Page click entries 348 detail when a user 300 requests access to a particular page 340 of a book 310. An analysis of page click records 348 can determine whether a user 300 has completed reading a book 310, which could then be recorded in the completion status record 316. Similarly, one embodiment of the present invention may record all search requests 370 made by a user 300. Search requests may relate to a particular book 310, or may be made over multiple books 310. Sessions 372 are used to keep track of a user's online status. Logins 374 track in the database 210 how often a user has logged into the site, and when they last logged in.

The system maintains records of user interactions with other users, such as when one user views the profile of another user (profile views 376), or when one user befriends another (record 378). As seen in other social networking environments, the linking of users 300 with friends allows users 300 to explore the interests and activities of their individually selected friends.

The database is also able to track synchronized reading sessions 380. This database entity contains the various preference settings selected by the user that created the reading session, such as the date and time of the synchronized reading session and whether the session will be open to the public or limited to invited users only. A synchronized reading session 380 is associated with a single book 310. Unlike most other database entities shown in FIG. 3, reading sessions can be associated with multiple users 300. One of these users 300 will be considered the speaker for the synchronized reading session 380 and the other users 300 will be considered participants for that session 380. The creator (frequently the speaker) of the reading session 380 is given the ability to alter the preferences for that session stored in database element 380.

In one embodiment, it is possible to record the interactions that occur at a synchronized reading session. This recorded information, which may include audio streams, new page instructions, message streams, notes, and video streams, are recorded in database element 382. This element 382 is associated with a single synchronized reading session 380, and each synchronized reading session 380 is associated with a single recording 382. A user that did not participate in the synchronized reading session 380 may be granted access to the recording 382 of that session 380, which is indicated by associating their user database element 300 with the appropriate recording 382 database element.

One benefit of participating in a synchronized reading session in which a book author participates as a speaker is that the author is able to create a digital autograph on the user's book. This digital autograph is saved as a database element 384 and is associated with a single user 300 and a single book 310. The autograph 384 serves as a digital equivalent of a signed, physical copy of a book, and can serve as a reminder that the user participated in a synchronized book reading session 380 with the author. The autograph 384 can contain a digital signature from the author to prevent faked autographs 384 that are not created by the book's true author. Furthermore, the autograph database entity 384 can contain notes written from the author to an individual user, thereby creating a personalized autograph 384 for that user 300 related to that book 310. In other embodiments, an author conducting a synchronized reading 380 for a book 310 can easily create an autograph 384 for all users 300 attending the synchronized reading 380.

User Reading Interface

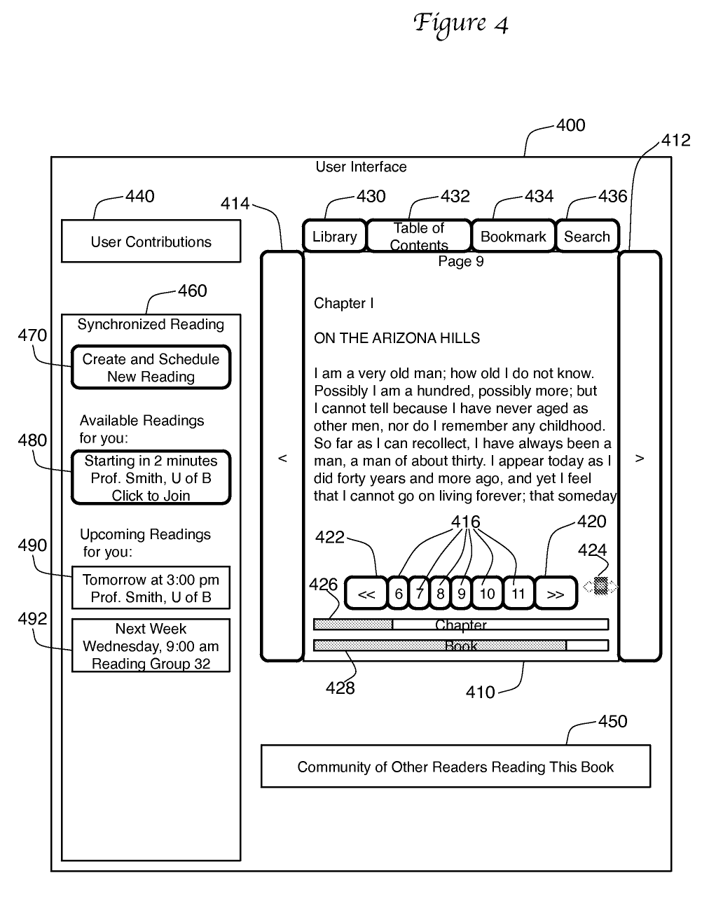

As explained above in connection with FIG. 2, a user will interact with the web-reading system of the present invention through a user interface 280 operating on a user computer 290. This user interface 280 is generated by the web server 260 operating on one or more server computers 200, and then transferred to the user computer 290 over the Internet 270, an intranet, or some other computerized network. FIG. 4 shows one embodiment of a user interface 400 that could be viewed by a user of the system of FIG. 2. This particular interface 400 is designed to allow a user to read a book that is stored in the database 210 accessed by the server computers 200. This database 210 may be constructed, in part, using the data entities shown in FIG. 3. This user interface 400 also allows a user to establish a synchronized reading session, to join a current session, or to view upcoming sessions.

To make it easier to read a book, the current page being read (element 410) dominates the interface 400. In the preferred embodiment, books are read page-by-page. Consequently, the reading user interface 400 presents a single page 410 to the user. To move the page displayed 410 from one page to the next, the user simply presses the next page button 412, which is preferable found along the entire right side of the page window 410. Similarly, the previous page button 414 is found along the entire left side of the page window 410. It is also possible to go to a different page by pressing one of the page specific buttons 416 found at the bottom of the page 410 being read. The pages displayed and activated by these buttons 416 can be altered by the forward 420 and reverse buttons 422. These page buttons 416-420, 422 can be removed from the interface 400 by pressing interface element 424, and can be recalled by pressing the same element 424.

At the bottom of the page window 410 are two progress bars 426, 428. These bars 426, 428 indicate at a glance how far the user currently is in the current chapter (bar 426) and the entire book (bar 428). At the top of the page window 410 are several menu buttons 430-436. The first button 430 brings the user to the library interface, where the user can select a new book. The table of contents button 432 presents the table of contents for the current book in the current page window 410. The bookmark button creates a bookmark database entry 344 for the current user at that page. Finally, the search button 346 presents the user with a search interface.

One of the benefits of the present invention is that users can review chapter comments and page notes associated with the page 410 currently being read. These user contributions to the page can be accessed through one or more user contribution interface elements 440 found on user interface 400. These elements 440 allow a user to make contributions such as notes, comments, reviews, ratings, and highlights, and also to review the contributions made by others. Another benefit of the present invention is the ability to find and interact with other users who are reading the same book. The community of other readers window 450 lists other users who are currently reading the same book as shown in window 410. Details concerning these elements can be found in the incorporated priority applications.

The reading interface 400 also includes a synchronized reading toolbox 460 that allows users to participate in the synchronized readings described above. The toolbox 460 includes an element such as button 470 that allows a user to indicate a desire to create a new synchronized reading session. In the preferred embodiment, all users can create a synchronized reading session if they so desire. In other embodiments, only authors, publishers, or identified leaders of groups 360 are allowed to create a new synchronized reading session.

The synchronized reading toolbar 460 also lists those synchronized reading sessions that are currently available 480 for the user. Although only one item 480 is shown in FIG. 4, it is possible that multiple sessions may be available for that user at a particular time. To participate in one of these synchronized reading sessions, the user clicks on the appropriate button 480 and the synchronized reading session will start. If the user created that synchronized reading session 480 or has otherwise been identified as the speaker for that session 480, the user will join with the ability to create the audio track for that synchronized reading session and also control the book page being viewed during that session. If the user is participating in that session 480 as a passive user and not a speaker, then the user will join as a participant of the session 480. The synchronized reading toolbar 460 also shows upcoming reading sessions 490, 492 for the current book. Since these sessions have not yet started, the user is not given the ability to join these sessions at this time.

All of the options shown in the synchronized reading toolbar 460 relate to the current book being reviewed by the user as shown in page element 410. If the user wishes to review the synchronized reading options for a different book, they can go back to their library (using button 430) and select a different book. Alternatively, a separate synchronized reading interface can be created that is not directly associated with any one book. This interface could be accessible from any book, or from any screen presented to the user by the computerized server system 100. In this case, the displayed synchronized reading sessions would identify not only the speaker and the time, but also the book being presented. If the user wished to create a new synchronized reading session, the user would be prompted to select the book that will be read during the synchronized reading session.

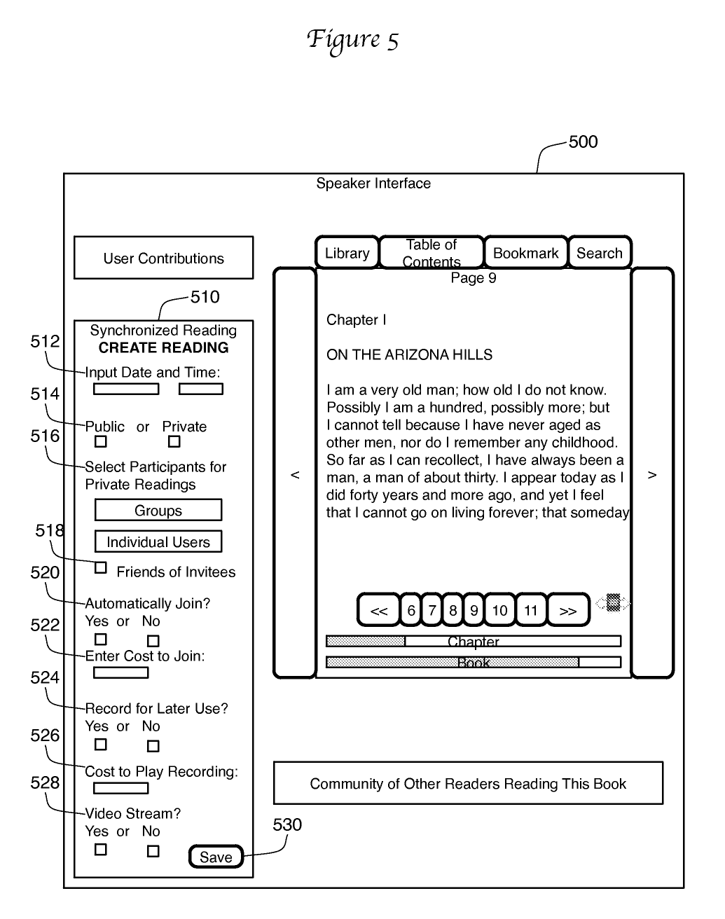

When a user elects to start a new synchronized reading session, the speaker interface 500 of FIG. 5 is shown. This interface 500 assumes that the user selected button 470 from the reading interface 400 shown in FIG. 4, and therefore includes many of the same elements as interface 400. The synchronized reading toolbar 510 has changed, however, to include the various options that must be selected in order to create a new synchronized reading session. The first option is to identify the date and time 512 for the reading session. Because participants for the synchronized reading session must be informed of the session before they can participate, most new synchronized reading sessions will be planned well in advance.

The creator of a synchronized reading session will also have to determine whether the session will be public or private at interface element 514. If the session is public, all users will be informed of the session and will be able to become participants of the session. With private synchronized reading sessions, only a select group of users will be informed of the session and be allowed to participate. If a private session is selected 514, the session creator will be able to select groups 360 or individual users 300 who will be invited to the session. In some cases, the creator may want to allow invited guests to bring additional friends to the synchronized reading session. This is allowed by selected the “friends of invitees” checkbox 518. In this is selected, users who are invited to the session are given an option to join the session at the appropriate time and also the option to invite other users 300 or groups of friends 360 to join as well.

If uninvited friends are allowed to participate, the creator may want the ability to allow participants to be screened when joining the session. Element 520 allows participants who are invited to join the session immediately upon indicating a desire to join by checking the “yes” box. By checking the “no” box, the creator of the session will be informed as each member joins the session and will have the ability to exclude participants on a case-by-case basis.

It is possible to charge users to participate in a synchronized reading session by filing in an amount in box 522. In one embodiment, the amount collected from participants is split between the creator of the synchronized reading session and the operators of the computerized system 100. In other embodiments, the author or publisher of the book will also be paid a portion of the money collected. In still further embodiments, only free synchronized reading sessions will be permitted.

At element 524, the creator can elect to record the synchronized reading session for later use. A recorded session includes the audio from the speaker synchronized to page turns during the synchronized reading session. In some embodiments, the recorded session can also include video, highlighting of text, notes, message streams, questions asked, user participation, and any other content that is shared during the synchronized reading session. If this content is recorded, a user that missed the live version of the synchronized reading session can replay the session in its entirety. If a recording is made, the creator can specify the cost, if any, that will be charged for replaying the recording at element 526.

At element 528, the creator can specify whether the synchronized reading session will include a video stream from the speaker. Finally, after specifying all of these options for the session, the creator can save these settings and create a new synchronized reading session by hitting the save button 530.

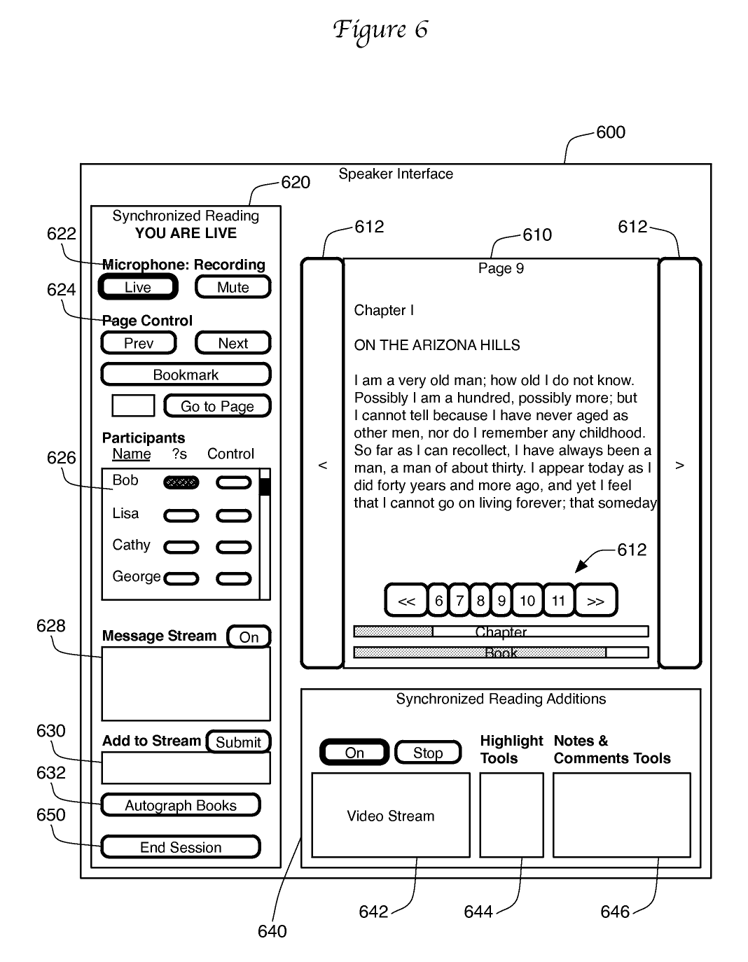

To begin the synchronized reading session, the designated speaker logs into the computerized system 100 and joins the session. In one embodiment, the speaker can allow participants to join the group before the official start time to ensure that the session is running properly and that the users are able to hear the speaker and view any other content provided by the speaker. While the synchronized reading session is active, the speaker will see an interface similar to the speaker interface 600 shown in FIG. 6. This interface shows the current page of the book being discussed in page element 610. The reader can change the page being displayed by pressing the standard change page buttons 612 that were described above in connection with FIG. 4. Any page changes made by the speaker during a live synchronized reading session will automatically be reflected in the pages being viewed by all of the participants in that session. Since the pages of the book are stored as separate database elements 340 in database 210, the speaker can be assured that all participants will see exactly the same words on their screen as the speaker sees in page element 610.

The speaker is able to control the synchronized reading session through the toolbox 620. The top of the toolbox 620 reminds that speaker that the synchronized reading session is live. The first buttons 622 presented in this toolbox control the microphone. If the microphone is live, the live button is emphasized to help remind the speaker that their voice is being carried to all the participants in the session. If the speaker desires, they can temporarily mute their microphone using the mute microphone control 622.

Although the standard page changing buttons 612 remain active, the synchronized reading toolbox 620 contains additional page control buttons 624. Some of these page buttons 624 are redundant, including a previous and next page button, while others allow the speaker to easily access a bookmarked page or to enter and go to a specific page in the book.

The synchronized reading toolbar 620 also provides a list of the current participants in window 626. As shown in FIG. 6, window 626 lists participants' names, and provides an indicator if the listed participant desires to ask a question. In FIG. 6, the area below the question header (“?s”) is filled in next to Bob's name, indicating that Bob wishes to ask a question. In one embodiment, the list 626 is sorted according to those users that indicated a desire to ask a question, so users who are awaiting an opportunity to speak are listed at the top of the list 626.

If and when the speaker desires to do so, the speaker can grant Bob the ability to ask a question. In the embodiment shown in FIG. 6, this is accomplished by clicking on the filled-in area under the question header next to Bob's name. When Bob is asking a question, the speaker's microphone is no longer live. Instead, Bob is given the opportunity to speak to the speaker and all the other participants of the synchronized reading session. Although it is not shown in FIG. 6, when Bob is asking a question the speaker interface 600 will indicate to the speaker that Bob now has control of the audio portion of the session. A control provided on this interface will allow the speaker to regain control of the audio portion when Bob has completed the question, or if Bob is not responsive or somehow acts inappropriately.

When Bob is asking a question, the speaker retains control over the page of the book being displayed during the session (as shown in element 610). It is possible for control of this aspect of the session to also be passed to a participant such as Bob. In one embodiment, this is accomplished by clicking on the control button next to Bob's name in list 626. When control has been passed, the participant provides both the audio component of the synchronized reading session and also controls the page to be displayed to all participants in the session. Although not shown in FIG. 6, the speaker interface 600 will clearly indicate when a participant has page control in the synchronized reading session, and will provide an ability for the speaker to immediately regain control over the page input and audio input to the session at any time.

In other embodiments, when a participant asks a question they are given access to the audio portion of the session, but the microphone of the speaker is not made inactive. Instead, audio is received from both the participant asking the question and the speaker. The remaining participants hear audio from both parties. This allows a method of having a conversation between a participant and a speaker without having to manually transfer control over the audio back and forth. Known techniques can be implemented to prevent feedback loops from interfering with the sound quality of the synchronized reading session.

In addition to asking questions, one embodiment of the present invention allows participants to engage in a message stream during the synchronized reading session. This message stream is displayed at element 628 in the toolbox 620 presented to the speaker. Should the speaker wish to contribute to the message stream, the speaker would type their contribution into the add-to-stream box 630 and click “submit.” The speaker's contribution would then be displayed at the top of the message stream shown on all of the participant's screens. As all new messages added to the stream 628 are placed on the top of the stream 628, the speaker's contribution can quickly be lost as other participants add new messages to the stream 628. In one embodiment, speaker contributions to the message stream are highlighted or otherwise emphasized in order to allow participants to easily recognize those contributions made by the speaker.

If the speaker is the author of a book, the toolbox 620 will include a mechanism 632 to autograph the books of the participants in the synchronized reading session. By clicking on this button 632, the speaker could automatically autograph the books of all participants in the session. As described above, the autograph would include a time and date element, and the speaker could add a note to the autograph. In one embodiment, all participants would receive the same autograph when the speaker presses interface element 632. In other embodiments, the speaker could autograph the books of only a subset of the participants, or could customize the comments included in the autograph for a particular participant.

In still another embodiment, the pressing of button 632 enters the computerized system 100 into an autograph mode. In this mode, interested participants in the synchronized reading session are placed into a queue. One at a time, they are allowed to interact with the speaker either through text communications, two-way audio communications, or a two-way video chat. This allows each participant a short period of time to interact directly with the speaker, and to request an individualized autograph of his or her book. Other participants who are either waiting in the queue or have obtained their autograph could view or hear the interaction of the speaker with the participant having their book being signed, but could not participate in the two-way communication.

The speaker interface 600 shown in FIG. 6 also includes an additional toolbox 640 for advanced features of the synchronized reading session. Element 642 shows a video stream window with “on” and “stop” control buttons at the top. If so desired by the speaker, this allows the speaker to capture a video stream of the speaker during the synchronized reading session. The video stream could originate, for example, from a camera mounted on the monitor used by the speaker computer system 292. The on button is highlighted in FIG. 6 to indicate that a video stream is currently being captured and shared. The window 642 allows the speaker to see the stream currently being shared with the participants of the session. In some embodiments, the video stream could contain content other than a video stream of the speaker. For instance, a speaker may have notes prepared for their reading that they wish to visually share with the participants. The notes may take the form of a presentation written in PowerPoint (by Microsoft Corp. of Redmond, Wash.) or Keynote (by Apple, Inc. of Cupertino, Calif.) software. The speaker may, for instance, read pages of the book and change pages 610 in synch with the reading. During this time, the video stream may include images of the speaker reading the book. After reading the selected portion, the speaker may then lecture on the reading, and change the video stream to include a Keynote presentation and related video embedded into that presentation. The mechanics of controlling a video stream and switching between a live video stream and presentation software are well known in the art and are not described further herein.

In addition to the video stream 642, the speaker may wish to highlight portions of the text of the pages 610 being read. The highlight tool box 644 provides the speaker with the appropriate tools to provide these highlights. The highlights of the currently displayed page 610 will be shared with all participants in the synchronized reading session. The details for the creation of highlights in a web-based reading environment are described in the incorporated, related application, Ser. No. 13/474,024.

Finally, the speaker may wish to share notes and comments related to the pages and chapter of the book being read with the participants of the synchronized reading session. These notes and comments can be created live during the session using tool box 646, or can be pre-created by the speaker and shared automatically during the session as soon as the appropriate page or section of the book is reached by the speaker. Alternatively, pre-written notes and comments related to the currently viewed page 610 can appear in box 646 and be shared with a particular command (such as pressing a “share” button) in the notes and comments toolbox 646.

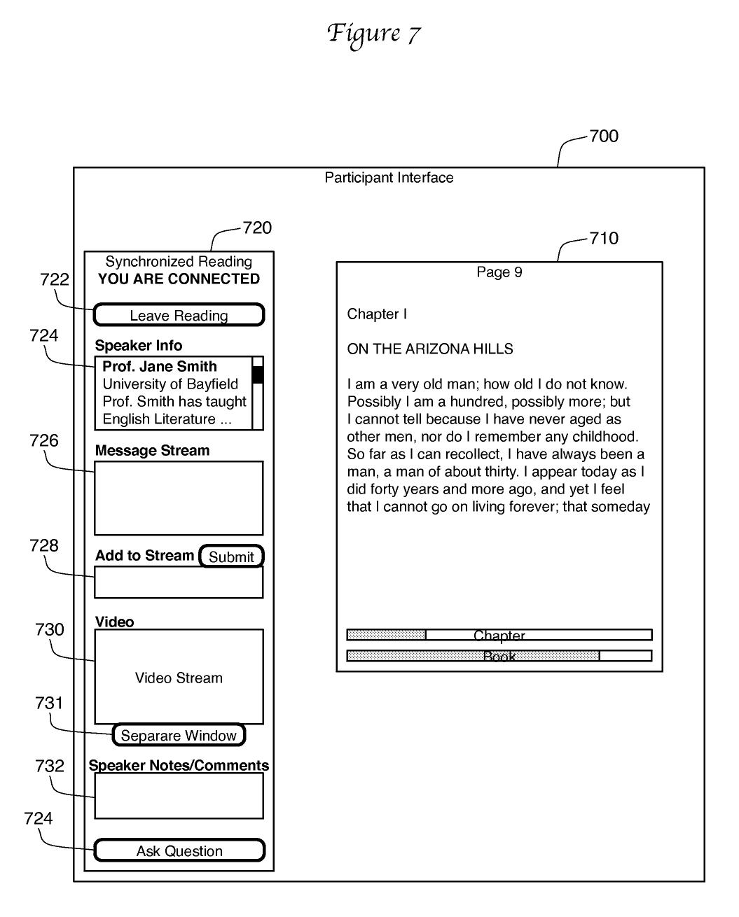

FIG. 7 shows a participant interface 700 that is viewed when a participant is viewing a synchronized reading session run by another. The interface shows the currently displayed page 710 in the book. Note that no page control elements appear on the interface 700, as the speaker for the synchronized reading session controls all page turns during the session. The interface 700 does include a synchronized reading toolbox 720 for use by the participant. The toolbox 720 states at the top that the user is connected to the session. The first element of the toolbox 720 is a button 722 that allows the participant to exit the synchronized reading session. This allows participants who inadvertently joined the session, or who became bored or otherwise wish to leave, an easy exit from the session. Once the participant exits the synchronized reading session, page controls are returned as the user returns to the normal reading interface 400 shown in FIG. 4.

Biographical information about the speaker is presented at element 724. This information can be stored in the database 210, such as in user element 300. Alternatively, a special biography can be created as part of the synchronized reading session creation process described above.

Element 726 displays the message stream created by the participants and speaker for the synchronized reading session. If the user wishes to contributed to the message stream, the user types their contribution into box 728 and hits the submit button. New contributions by participants are added to the top of the message stream 726.

Element 730 displays the video stream being shared by the speaker. In some cases, the participant may wish to increase the size of the video stream. To simplify this process, a button 731 on the interface 700 opens a new window (such as a browser window) containing the video stream. This new window can be resized as desired. As is known in the prior art, different resolutions of video can be provided to this window under the control of the participant. In this manner, a user with a two screen computing environment 290 can fill one screen with the video stream while using the other screen for the remaining elements of the participant interface 700.

Finally, if the speaker is sharing notes and comments, these items will appear in interface element 732. In one embodiment, when notes or comments are shared with a participant during a synchronized reading session, those notes and comments remains available to the user even after the synchronized reading session is ended. As explained in the incorporated priority applications, shared notes and comments can be accessed when a user reads a book, and can prove useful for understanding the meaning or context of a document.

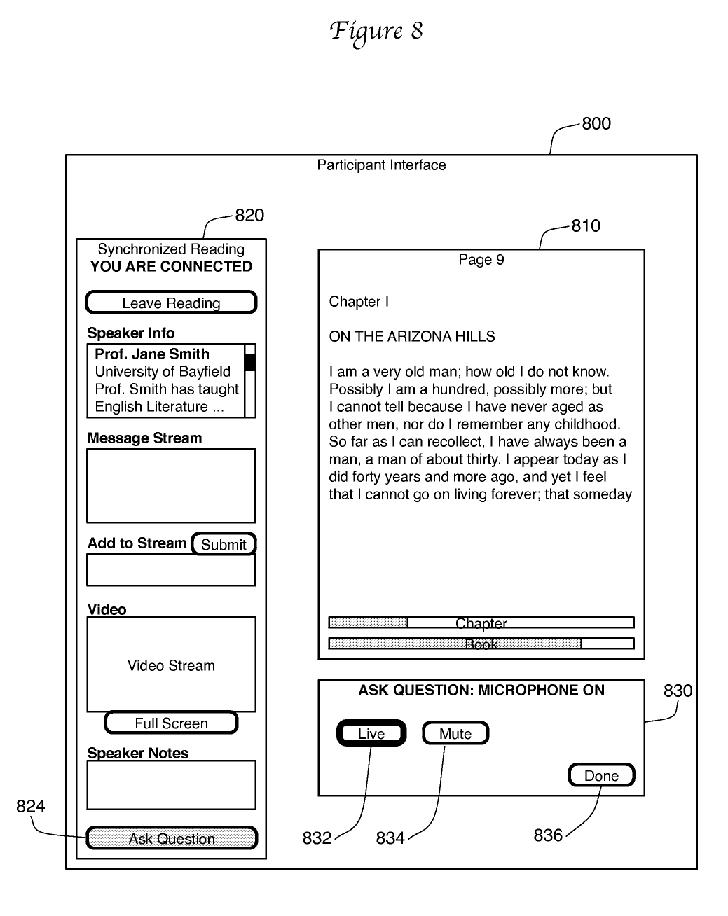

If a participant wishes to ask a question, he or she presses button 724. As explained in connection with FIG. 6, the speaker will be notified that the participant has asked a question and can, at some time, allow the user to ask the question by giving the user access to the audio stream. When this occurs, the participant interface 800 is modified to include an ask question component 830, as shown in FIG. 8. In this interface 800, the page view 810 and synchronized reading toolbox 820 components remain essentially unchanged, although the ask question button 824 is grayed out to indicate that the participant is currently asking a question.

The ask question component 830 clearly informs the participant that their microphone is live by the title at the top of component 830 and by bolding element 832. When the microphone is live, anything said by the participant will be broadcast to the other members of the synchronized reading session. If the participant temporarily wishes to mute their microphone, they need only hit button 834. To unmute the microphone, they may hit either the live button 832 or, in some embodiments, re-hit the mute button 834. When the user is done with asking their question, the participant presses the done button 836. This transmits a question completed instruction back to the server computers 200, indicating that the audio feed from the participant's user computer 290 should be cut off, the microphone component 830 should be removed, and the participant interface should return to form 700 shown in FIG. 7.

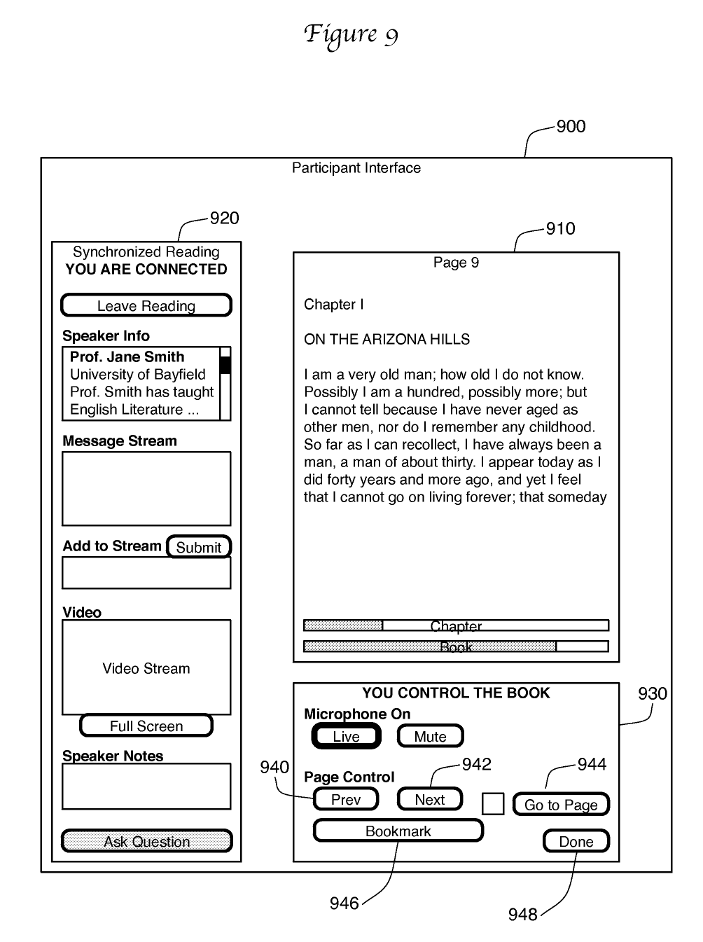

In some circumstances, the speaker may transfer page-change control over the synchronized reading session to the participant. At that time, the participant interface will include a control component 930 shown as part of interface 900 in FIG. 9. This component contains the same microphone controls as the ask question component 830. In addition, the participant interface 900 includes an ability to control the pages being viewed 910 by the entire synchronized reading session. These controls include a previous page button 940 and a next page button 942, a go to page input box and button 944, and a go to bookmark button 946. These buttons function in the same way as the similar buttons described in connection with the speaker interface 500. When the participant wishes to relinquish control of the pages shown in the session, he or she will hit the done button 948. This transmits a relinquish control instruction to the server computers 200, which causes the server 200 to return control to the speaker interface 500 and to remove the control element 930 from the participant interface 900 (thereby returning the participant to interface 700).

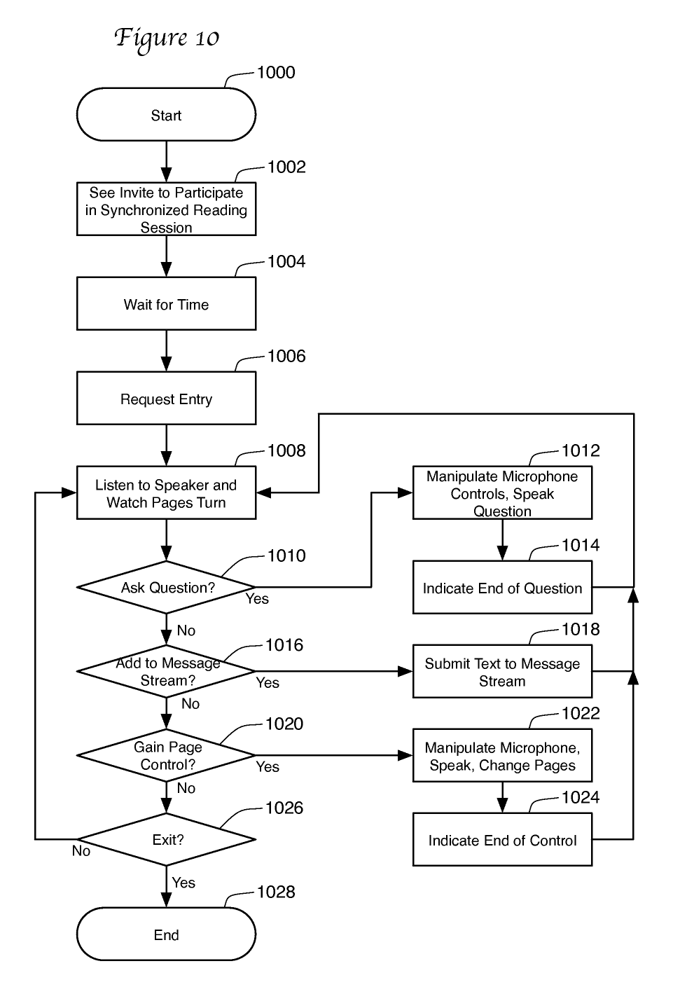

FIG. 10 shows a method by which a user can participate in a synchronized reading session. The first step is that the computerized system 100 shows an invitation to the user to participate in the synchronized reading session at step 1002. When the participant sees this invitation, they wait until the time that the synchronized reading session starts (step 1004) and then request entry into the session in step 1006. Entry may be granted automatically to all invited participants, or the server computers 200 may allow the speaker to accept or reject requests to participate in the synchronized reading session.

Assuming that the participant has been granted entry to the session, the participant then listens to the audio stream of the speaker while watching the book pages as controlled by the speaker. This occurs at step 1008. If the participant wishes to ask a question at step 1010, the participant interface sends a question request to the speaker interface via the server computers 200. If the speaker selects the participant to ask a question, the speaker interface sends an instruction to the server 200 that identifies the participant and instructs the server 200 to allow that participant to ask a question. The question asking interface elements are then presented to the identified participant, which allows the participant to turn on and off their microphone and to ask their question (step 1012). When the question has been asked, the participant indicates that the question is complete in step 1014, typically by hitting a “done” button 836 on their interface. This sends a completed question message to the server 200, which removes the question interface from the participant's interface and returns audio control to the speaker. The participant returns to listening to the speaker and watching the pages at step 1008.

If the participant wishes to add a message to the message stream (at step 1016), they type text into the add to message stream box 728 and hit the submit button on their interface (step 1018). This sends the text and the add to message stream command to the server 200, which then updates the message stream shown on the interfaces of the participants and speaker of the synchronized reading session. The participant then returns to step 1008.

In some circumstances, the speaker may cede page control to the participant. If this occurs at step 1020, the speaker sends a command to the server 200 identifying the participant that should receive page control for the synchronized reading session. The server system 200 then updates the interface 900 for that participant to include the page control elements 930, allowing the participant to turn on and off their microphone and to submit page change requests (step 1022). Audio input from the participant is sent to the server system 200 and shared with all users in the synchronized reading session. Similarly, page change instructions from the interface 930 of the participant are sent to the server 200, which then updates the page being shown by the interfaces of all users within the synchronized reading session. The participant can relinquish control, such as by hitting done button 948, which sends a relinquish control instruction to the server system 200. The server 200 then removes the page control elements 930 from the participant's interface and informs the speaker interface that it now has page control for the session. The participant then returns to step 1008.

At any time, the participant can exit the synchronized reading session at step 1026, such as by pressing the “Leave Reading” button 722 on the participant interface 700. If this occurs, the participant interface 700 is changed back to the reading interface 400 for the book and the synchronized reading session is ended for that participant at step 1028.

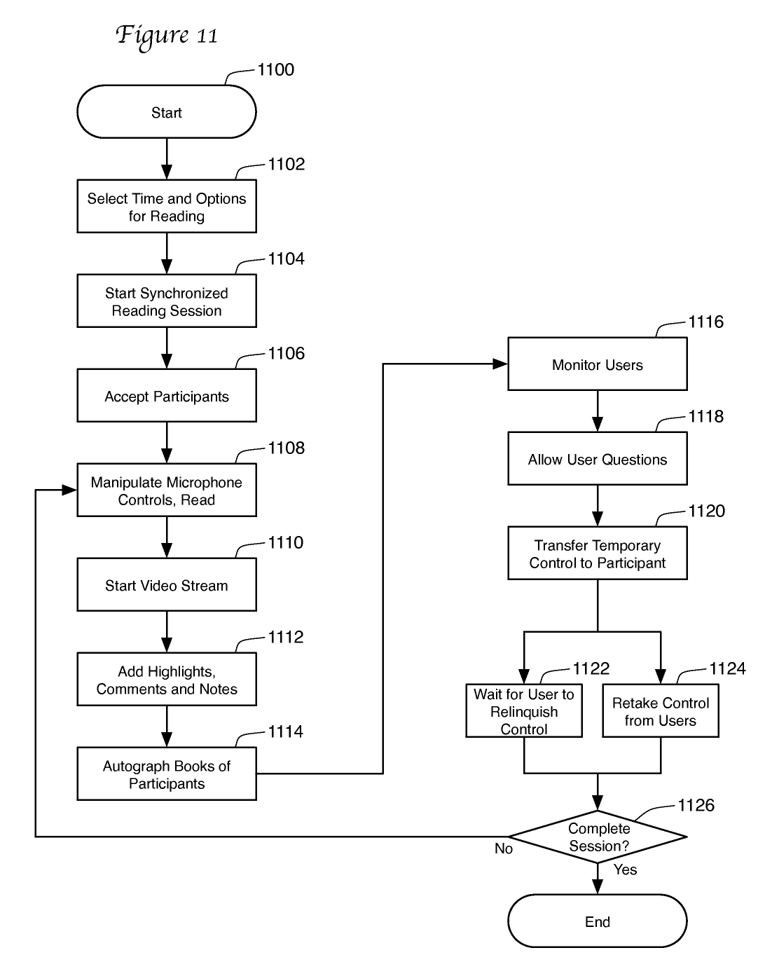

FIG. 11 shows the method 1100 for managing a synchronized reading session as a speaker. The method 1100 starts by creating a synchronized reading session at step 1102, such as through interface 500 shown in FIG. 5. Using this interface, the speaker will specify the time and date for the reading session, the book involved, and the particular options desired for this session. When the session has been created, the speaker waits for the appropriate time and then begins the synchronized reading session at step 1104. Once the session has begun, participants can join in. In some embodiments, the speaker has the ability to accept and reject participants wishing to enter the session. At step 1106, the speaker accepts at least some of the participants wishing to join the session.

At step 1108, the speaker begins the synchronized reading session by using the microphone controls 622 and speaking to the participants. In one embodiment, the speaker reads a portion of the book to the participants. The audio stream from the speaker interface 600 is sent to the server computers 200, which shares this audio with the participants in the synchronized reading session. While reading, the speaker changes the pages of the book by using the speaker's page change controls 624. These controls 624 send change page commands from the speaker interface 600 of the speaker computer 292 to the server 200, which changes the page that is shown by the participant interface 700 at the user computers 290.

In some embodiments, the speaker may also wish to share a video stream, which is initiated at step 1110. The speaker computer 292 transfers the video stream to the server computers 200, which then shares the video stream with participant computers 290 through participant interface 700. Similarly, the speaker uses interface elements 644, 646 to share highlights, comments and notes with participants at step 1112.

At step 1114, the speaker indicates a desire to autograph the books of the participants, such as by pressing interface button 632. In one embodiment, this sends an autograph book instruction to the server computers 200, which then create the appropriate autograph entries 384 in the database 210 for the users 300 that are participating in the synchronized reading session. In other embodiments, direct interaction between the speaker and the participants is made possible by entering into an autograph session, as described above.

At step 1116, the speaker monitors the list of participants 626 in the session to see if any participant has a question. If so, the speaker can elect to allow that participant to contribute a question by causing the speaker interface 600 to send an instruction to the server system 200 that identifies the participant and instructs the server 200 to allow that participant to ask a question as described above. This transfers temporary control over the audio in the synchronized reading session to the selected participant, as shown in step 1120. As also described above, the speaker can grant page-changing control to the participant as well at step 1120.

At this point, the speaker can wait for the participant to relinquish control, such as by pressing “done” buttons 836 or 948. This occurs at step 1122. In some circumstances, however, the speaker will desire control to be denied to the participant before the participant relinquishes control. This is accomplished to by pressing a revoke or cancel control icon or button on the speaker interface 600 at step 1124. This sends a cancelation or revocation command to the server computer 200, which alters the participant interface to remove the control elements and returns control to the speaker computer 292.

At any time, the speaker can end the synchronized reading session, such as by pressing an “End Session” button 650 on the speaker interface 600. When the speaker ends the session at step 1126, the participants are informed that the session has ended. In one embodiment, the participants will be allowed to view the message stream and the other content on the participant interface 700 after the termination of the session. Participants can close the participant interface 700 and return to the reading interface 400 by clicking on the “Leave Reading” button 722. If the speaker does not wish to end the synchronized reading session, the speaker returns to step 1108.

If the synchronized reading session were recorded by the server computers 200, all inputs by the speaker at steps 1108, 1110, 1112, and all questions and contributions by the participants at steps 1012, 1018, and 1022 will be recorded and stored in a recording database entity 382 (which may actually consist of a plurality of separate entities in a database 210). This recording can then be accessed again by other users, who could then re-create the experience of participating in the synchronized reading session, although the viewer of the recording could not ask questions or participate in the message stream.

Of course, the system and methods described above are exemplary and are not the exclusive techniques for using the disclosed embodiments. Numerous modifications and variations will readily occur to those skilled in the art. Since such modifications are possible, the invention is not to be limited to the exact construction and operation illustrated and described. Rather, the present invention should be limited only by the following claims.

What is claimed is:

1. A method of conducting a synchronized reading session among multiple users of an Internet-based reading system comprising:
on at least one server computer having a processor and tangible, non-transitory computer-readable data storage containing structured data in a computerized database,
a) at the server computer, creating a computerized speaker interface allowing a first user to control the synchronized reading session and transmitting the speaker interface over a network interface to a speaker computer;
b) at the server computer, creating a computerized participant interface allowing a second user to participate in the synchronized reading session and transmitting the participant interface over the network interface to a first participant computer;
c) at the server computer, receiving speaker audio from the speaker computer via the speaker interface;
d) at the server computer, transmitting the speaker audio to the first participant computer to output the speaker audio via the participant interface;
e) at the server computer, receiving a page turning instruction from the speaker computer via the speaker interface;
f) at the server computer, determining a new page for a publication based on the page turning instructions received from the speaker interface; and
g) transmitting the new page of the publication to both the speaker interface of the speaker computer and the participant interface of the first participant computer.

2. The method of claim 1, further comprising:
h) at the server computer, receiving a question instruction from the speaker computer via the speaker interface, the question instruction identifying the first participant computer;
i) at the server computer and after receiving the question instruction, ceasing to transmit speaker audio to the first participant computer;
j) at the server computer, receiving question audio from the first participant computer via the participant interface; and
k) at the server computer, transmitting the question audio to the speaker computer to output the question audio via the speaker interface.

3. The method of claim 2, further comprising:
l) at the server computer, receiving a complete question instruction from the first participant computer via the participant interface;
m) at the server computer and after receiving the complete question instruction, ceasing to transmit question audio to the speaker computer, receiving speaker audio from the speaker computer via the speaker interface, and transmitting the speaker audio to the first participant computer to output the speaker audio via the participant interface.

4. The method of claim 2, further comprising:
l) at the server computer and after receiving the question instruction, receiving a cancel question instruction from the speaker computer via the speaker interface;
m) at the server computer and after receiving the cancel question instruction, ceasing to transmit question audio to the speaker computer, receiving speaker audio from the speaker computer via the speaker interface, and transmitting the speaker audio to the first participant computer to output the speaker audio via the participant interface.

5. The method of claim 1, further comprising:
h) at the server computer, receiving a transfer control instruction from the speaker computer via the speaker interface, the transfer control instruction identifying the first participant computer;
i) at the server computer, adding a page control element to the participant interface and transmitting the page control element over the network interface to the first remote participant computer;
j) at the server computer, ceasing to respond to page turning instructions from the speaker computer after receiving the transfer control instruction from the speaker computer;
k) at the server computer, receiving a page turning instruction from the first participant computer via the page control element;
l) at the server computer, determining a next page for the publication based on the page turning instructions received from the page control element of the first participant computer; and
m) at the server computer, transmitting the next page of the publication to both the speaker interface of the speaker computer and the participant interface of the first participant computer.

6. The method of claim 5, further comprising:
n) at the server computer, receiving a relinquish control instruction from the first participant computer via the page control element;
o) at the server computer and after receiving the relinquish control instruction from the first participant computer, ceasing to respond to page turning instructions from the first participant computer and responding again to page turning instructions from the speaker computer via the speaker interface.

7. The method of claim 5, further comprising:
n) at the server computer, receiving a cancel control transfer instruction from the speaker computer;
o) at the server computer and after receiving the cancel control transfer instruction from the speaker computer, ceasing to respond to page turning instructions from the first participant computer and responding again to page turning instructions from the speaker computer via the speaker interface.

8. The method of claim 1, further comprising:
h) at the server computer, recording the speaker audio and the page turning instructions for later recall, the page turning instructions each being associated with a time during the speaker audio at which the page turning instructions were received;
i) at the server computer, transmitting the recorded speaker audio to a third participant computer;
j) at the server computer, transmitting different pages of the publication to the third participant computer during the transmission of the recorded speaker audio, with each page timed according to the original receipt of the page turning instructions recorded with the speaker audio.

9. The method of claim 1, further comprising:
h) at the server computer, receiving speaker notes from the speaker computer via the speaker interface while receiving the speaker audio from the speaker computer,
i) at the server computer, transmitting the speaker notes to the first participant computer for display on the participant interface while transmitting the speaker audio to the first participant computer.

10. The method of claim 9, further comprising:
j) at the server computer, recording the speaker audio, the page turning instructions, and the speaker notes for later recall, the page turning instructions each being associated with a time during the speaker audio at which the page turning instructions were received;
i) at the server computer, transmitting the recorded speaker audio and the speaker notes to a third participant computer;
j) at the server computer, transmitting different pages of the publication to the third participant computer during the transmission of the recorded speaker audio, with each page timed according to the original receipt of the page turning instructions recorded with the speaker audio.

11. The method of claim 1, further comprising:
h) at the server computer, receiving speaker video from the speaker computer via the speaker interface; and
i) at the server computer, transmitting the speaker video from to the first participant computer to output the speaker video via the participant interface.

12. A method of conducting a synchronized reading session among multiple users of an Internet-based reading system comprising:
on at least one server computer having a processor and tangible, non-transitory computer-readable data storage containing structured data in a computerized database,
a) at the server computer, creating a computerized speaker interface and transmitting the speaker interface over a network interface to a speaker computer;
b) at the server computer, creating a computerized participant interface and transmitting the participant interface over the network interface to a first participant computer and a second participant computer;
c) at the server computer, receiving speaker audio from the speaker computer via the speaker interface;
d) at the server computer, transmitting the speaker audio to the first and second participant computers to output the speaker audio via the participant interface;
e) at the server computer, receiving a page turning instruction from the speaker computer via the speaker interface;
f) at the server computer, determining a new page for a publication based on the page turning instructions received from the speaker interface; and
g) transmitting the new page of the publication to the speaker interface of the speaker computer and the participant interface of the first and second participant computers.

13. The method of claim 12, further comprising:
h) at the server computer, receiving a question instruction from the speaker computer via the speaker interface, the question instruction identifying the first participant computer;
i) at the server computer and after receiving the question instruction, ceasing to transmit speaker audio to the first and second participant computers;
j) at the server computer, receiving question audio from the first participant computer via the participant interface; and
k) at the server computer, transmitting the question audio to the speaker computer and to the second participant computer.

14. The method of claim 13, further comprising:
l) at the server computer, receiving one of a complete question instruction from the first participant computer and a cancel question instruction from the speaker computer;
m) at the server computer and after step l), ceasing to transmit question audio to the speaker computer and the second participant computer, receiving speaker audio from the speaker computer via the speaker interface, and transmitting the speaker audio to the first and second participant computers.

15. The method of claim 12, further comprising:
h) at the server computer, receiving a transfer control instruction from the speaker computer via the speaker interface, the transfer control instruction identifying the first participant computer;
i) at the server computer, transmitting a page control interface element over the network interface to the first remote participant computer;
j) at the server computer, ceasing to respond to page turning instructions from the speaker computer after receiving the transfer control instruction from the speaker computer;
k) at the server computer, receiving a page turning instruction from the first participant computer via the page control element;
l) at the server computer, determining a next page for the publication based on the page turning instructions received from the page control element of the first participant computer; and
m) at the server computer, transmitting the next page of the publication to the speaker interface of the speaker computer and the participant interface of the first and second participant computers.

16. The method of claim 15, further comprising:
n) at the server computer, receiving one of a relinquish control instruction from the first participant computer and a cancel control transfer instruction from the speaker computer;
o) at the server computer and after step n), ceasing to respond to page turning instructions from the first participant computer and responding again to page turning instructions from the speaker computer via the speaker interface.

17. A server computer system comprising:
a) at least one processor for processing computer instructions;
b) a network interface for communicating with a speaker interface operating on a speaker computer and a participant interface operating on a first participant computer;
c) tangible, non-transitory computer readable memory:
d) structured data residing on the non-transitory memory containing pages constituting a pre-defined portion of a publication;
e) programming instructions residing on the non-transitory memory, the programming instructions instructing the processor to:
i) receive speaker audio over the network interface from the speaker interface operating on the speaker computer;
ii) transmit the speaker audio to the participant interface operating on the first participant computer;
iii) receive a page turning instruction from the speaker interface operating on the speaker computer;
iv) determine a new page from the structured data based on the page turning instructions received from the speaker interface; and
v) transmit the new page to both the speaker interface of the speaker computer and the participant interface of the first participant computer.

18. The server computer system of claim 17, wherein the network interface communicates with a second participant computer operating the participant interface, and further wherein the programming instructions transmit the speaker audio and the new page to the participant interface operating on the second participant computer.

19. The server computer of claim 18, wherein the programming instructions further instruct the processor to:
vi) receive a transfer control instruction from the speaker interface operating on the speaker computer, the transfer control instruction identifying the first participant computer;
vii) transmit a page control interface element over the network interface to the participant interface operating on the first participant computer;
viii) cease responding to page turning instructions from the speaker computer;
ix) receive a page turning instruction from the page control element;
x) determine a next page for the publication based on the page turning instructions received from the page control element; and
xi) transmit the next page of the publication to the speaker interface operating on the speaker computer and the participant interfaces operating on the first and second participant computers.

20. The server computer of claim 17, wherein the structured data contains user records associating users with publications, and further wherein the programming further instruct the processor to:
vi) receive an autograph book instruction from the speaker interface operating on the speaker computer;
vii) associate in the structured data a speaker autograph associated with the publication and the users operating the first and second participant computers, the speaker autograph confirming the receipt of the autograph book instruction from the speaker computer while the users operating the first and second participant computers were in communication over the server computer with the speaker operating the speaker computer.
